(19) United States
(12) Patent Application Publication
(10) Pub. No.: US 2013/0096897 A1
(43) Pub. Date: Apr. 18, 2013

(54) RESERVOIR MODELING WITH 4D SATURATION MODELS AND SIMULATION MODELS

(71) Applicant: Saudi Arabian Oil Company, Dhahran (SA)

(72) Inventor: Ali Shahri, Doha (SA)

(73) Assignee: Saudi Arabian Oil Company, Dhahran (SA)

(21) Appl. No.: 13/654,909

(22) Filed: Oct. 18, 2012

Related U.S. Application Data
(60) Provisional application No. 61/548,508, filed on Oct. 18, 2011.

(51) Int. Cl. G06G 7/57

(52) U.S. Cl. 703/10

(57) ABSTRACT

Production based saturation models of subsurface reservoirs of interest are formed in a computer based on data from well logs, production data and core data. Data of these types obtained over a period of time are used to form 4-D actual or measured production based saturation models of a reservoir illustrative of fluid movement in the reservoir over time. Simulation models of fluid saturation of the reservoir are also formed for comparable times. Composite models of the production based saturation models and the simulation models are formed for analysts to evaluate accuracy of the simulation models of the reservoir taking into account production experience. The simulation models can then be adjusted for changes noted in the reservoir and based on how gas and water have actually moved within the reservoir over time.

### CROSS REFERENCE TO RELATED APPLICATION

This application claims priority and is related to U.S. Provisional Patent Application No. 61/548,508 filed Oct. 18, 2011 titled, “Reservoir Modeling with 4D Saturation Models and Simulation Models” which is incorporated by reference in its entity.

The present invention relates to fluid saturation modeling of subsurface reservoirs, as does commonly owned U.S. Non-Provisional patent application “4D SATURATION MODELING” (Attorney Docket No. 004159.007066) filed of even date herewith, of which applicant is investor.

### BACKGROUND OF THE INVENTION

1. Field of the Invention

The present invention relates to computerized modeling of subsurface reservoirs, and in particular to forming models of saturation based on measurements made in or about the reservoir during its production life.

2. Description of the Related Art

In the oil and gas industries, the development of underground hydrocarbon reservoirs typically includes development and analysis of computer models of the reservoir. These underground hydrocarbon reservoirs are typically complex rock formations which contain both a petroleum fluid mixture and water. The reservoir fluid content usually exists in two or more fluid phases. The petroleum mixture in reservoir fluids is produced by wells drilled into and completed in these rock formations.

A geologically realistic model of the reservoir, and the presence of its fluids, helps in forecasting the optimal future oil and gas recovery from hydrocarbon reservoirs. Oil and gas companies have come to depend on geological models as an important tool to enhance the ability to exploit a petroleum reserve. Geological models of reservoirs and oil/gas fields have become increasingly large and complex, in such models, the reservoir is organized, into a number of individual cells. Seismic data with increasing accuracy has permitted the cells to be on the order of 25 meters areal (x and y axis) intervals. For what are known as giant reservoirs, the number of cells is the least hundreds of millions, and reservoirs of what is known as giga-cell size (a billion cells or more) are encountered.

The presence and movement of fluids in the reservoir varies over the reservoir, and certain characteristics or measures as water or oil saturation and fluid, encroachment made during production from, existing wells in a reservoir, are valuable in the planning and development of the reservoir.

When characterizing and developing a reservoir field, a model of the reservoir covering the entire reservoir has been required to be built to provide an accurate model for reservoir planning. Accurate indications of the presence and movement of reservoir are an essential input in fluids in reservoir evaluation and planning.

Modeling of the presence and movement of reservoir fluids over a projected reservoir life has been based on reservoir simulation models. An example of such, a simulation model is that of U.S. Pat. No. 7,526,418, which is owned by the assignee of the present invention. However, calibration of the simulation model and confirmation that the simulation model continued to represent the reservoir presented a challenge. Additionally, additional reservoir Information, such as the presence of faults, was often gained, about the reservoir during production. So far as is known, it was problematic to accurately incorporate the additional information into simulation models.

### SUMMARY OF THE INVENTION

Briefly, the present invention provides a sew and improved computer implemented method of obtaining measures in a data processing system of fluid saturation of a subsurface reservoir from a simulation model and from a production based model from data measurements of wells in the reservoir during production. The computer implemented of the present invention processes initial data about formations in the reservoir received from wells in the reservoir to determine art initial measure of fluid saturation of formations in the reservoir at an initial time. The determined initial, measure of fluid saturation in formations of interest in the reservoir is transferred to a data memory of the data processing system. Production data during production subsequent to the initial time from wells in the reservoir is processed to determine production based measures of fluid saturation of formations during production. The determined production based measures of fluid saturation of formations in the reservoir are assembled in the data memory. A simulation model of fluid saturation of formations in the reservoir is also determined. A composite display of the simulation model of fluid saturation and the determined production based measures of fluid saturation in formations of interest in the reservoir is then formed for comparative analysis.

The present invention provides a new and improved data processing system for obtaining measures of fluid saturation of a subsurface reservoir from a simulation model and from a production based model from data measurements of wells in the reservoir during production. The data processing system includes a processor which processes initial data about formations in the reservoir received from wells in the reservoir to determine an initial measure of fluid saturation of formations in the reservoir at an initial time. The processor also transfers the determined initial measure of fluid saturation in formations of interest in the reservoir to a data memory of the data processing system. The processor also, based on production data during production subsequent to the initial time from wells in the reservoir, determines production based measures of fluid, saturation of formations during production. The determined production based measures of fluid saturation of formations in the reservoir are assembled in the memory. The processor also determines a simulation model of fluid saturation of formations in the reservoir. An output display of the data processing system forms a composite display of the simulation model of fluid saturation and the determined production based measures of fluid saturation in formations of interest in the reservoir for comparative analysis.

The present invention also provides a new and improved data storage device having stored in a computer readable medium computer operable instructions for causing a data processing system to obtain measures of fluid saturation of a subsurface reservoir from, a simulation model and from a production based model from, data measurements of wells in the reservoir during production. The instructions stored, in the data storage device causing the data processing system to process initial data about formations in the reservoir received from wells in the reservoir to determine an initial measure of fluid saturation of formations in the reservoir at an initial time, and transfer the determined initial measure of fluid saturation in formations of interest in the reservoir to a data memory of the data processing system. The instructions also cause the data processing system to process production, data, during production subsequent to the initial time from wells in the reservoir to determine production based measures of fluid saturation of formations during production, and assemble in the memory the determined production based measures of fluid saturation of formations in the reservoir. The instructions stored in the data storage device also cause the processor to determine a simulation model of fluid saturation of formations in the reservoir and cause the data processing system to form a composite display of the simulation model of fluid saturation and the determined production based measures of fluid saturation in formations of interest in the reservoir for comparative analysis.

### BRIEF DESCRIPTION OF THE DRAWINGS

FIG. 1 is a functional block diagram of a set of data processing steps performed in a data processing system for reservoir modeling with production based 4D saturation models and simulation models of fluid saturation of subsurface earth formations according to the present invention.

FIG. 2 is a functional block diagram of an initial set of data processing steps of production based 4D saturation modeling of the diagram of FIG. 1.

FIG. 3 is a functional block diagram of a subsequent set of data processing steps of production based 4D saturation, modeling of the diagram of FIG. 1.

FIG. 4 is a schematic block diagram of a data processing system for reservoir modeling with production based 4D saturation models and simulation models of fluid saturation of subsurface earth formations according to the present invention.

FIG. 5 is a display of a 4D production based saturation model according to the present invention for a region of interest in a subsurface reservoir at a particular time during it production life.

FIG. 6 is a composite display according to the present invention of fluid saturation of a subsurface reservoir from a simulation model and from a production based model for a geological model at a depth of interest in a reservoir.

FIGS. 7A, 7B, 7C and 7D are displays according to the present invention of differences between fluid saturation measures from a simulation model and from a production, based model at depths of interest in a reservoir.

FIG. 7E is an enlarged display of a color key used in conjunction with the displays of FIGS. 7A through 7D.

FIG. 8A is a display according to the present invention of differences between fluid saturation measures from a simulation model and from a production based model at a depth, of interest in a reservoir.

FIG. 8B is a vertical cross-sectional of the saturation model according to the present invention, for a region of interest in the subsurface reservoir of FIG. 8A at a particular time in its production life.

FIG. 8C is an enlarged display of a color key used in conjunction with the displays of FIGS. 5A and 5B.

FIG. 9A is a plot of comparative measures regarding of reservoir fluid parameters as functions of time, based on a saturation model according to the present invention for a region of interest in a subsurface reservoir.

FIG. 9B is a plot of measures regarding of reservoir fluid parameters as functions of depth based on a saturation model according to the present invention for a well of interest in a subsurface reservoir.

FIG. 10A is a vertical cross-sectional composite display of a fluid saturation according to the present invention for a region of interest in a subsurface reservoir at a particular time in its production life.

FIG. 10B is a display according to the present invention of differences between fluid saturation measures from a simulation model and from a production based model at a depth of Interest in the same reservoir as FIG. 10A.

FIG. 10C is a display in an Isometric view according to the present invention of differences between fluid saturation measures from a simulation model and from a production based model at a depth of interest in the same reservoir as FIG. 10A.

FIG. 11A is a plot of comparative measures regarding of reservoir fluid parameters as functions of time based on a saturation model according to the present invention for a region of interest in a subsurface reservoir.

FIG. 11B is a plot of measures regarding of reservoir fluid parameters as functions of depth based on a saturation model according to the present invention for a well of interest in a subsurface reservoir.

### DETAILED DESCRIPTION OF THE PREFERRED EMBODIMENTS

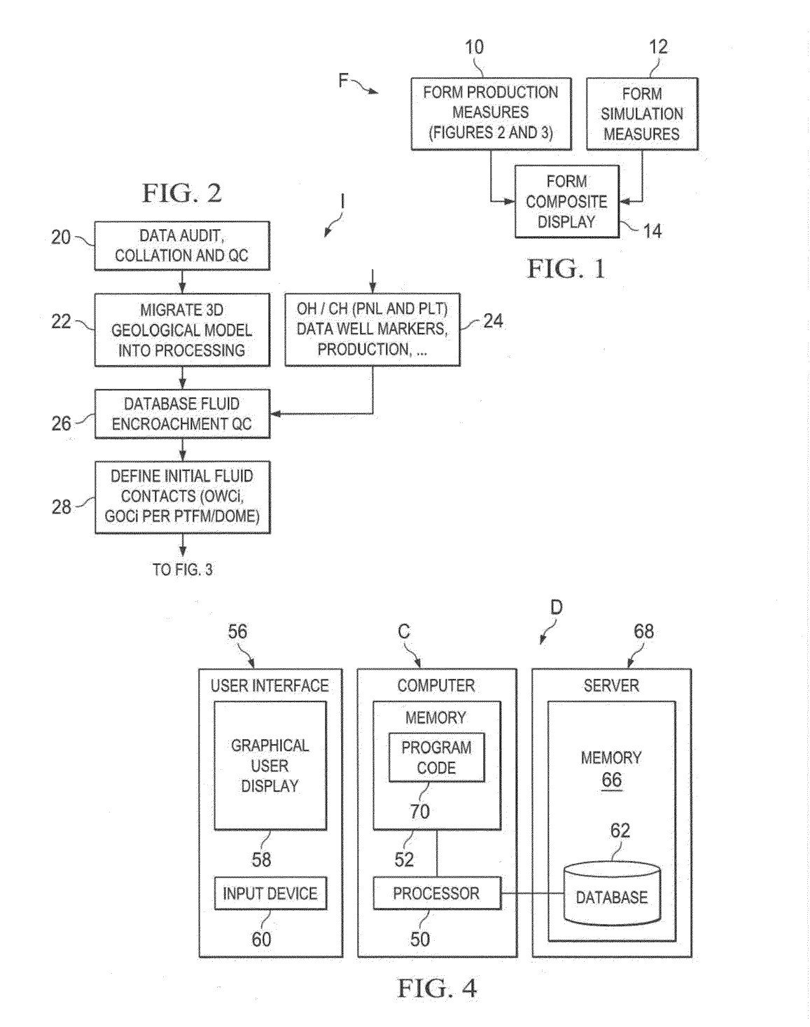

In the drawings, a flowchart F shown in FIG. 1 illustrates the basic computer processing sequence of the present invention for reservoir modeling with production based 4D saturation models and simulation models of fluid saturation of subsurface earth formations according to the present invention. The steps Illustrated in FIG. 1 each represent formation of a 4D model. During step 12, a static reservoir saturation model over time is formed, while step 10 represents formation of a history matched simulation model. Step 14 represents from composite display from both, models formed during steps 10 and 12 to compare the calculated saturation (from the simulation model) with the actual saturation from the static model. The location and the time can be changed as desired. The processing of data according to FIG. 1 of a subsurface reservoir modeling is performed in a data processing system D (FIG. 4) as will be described.

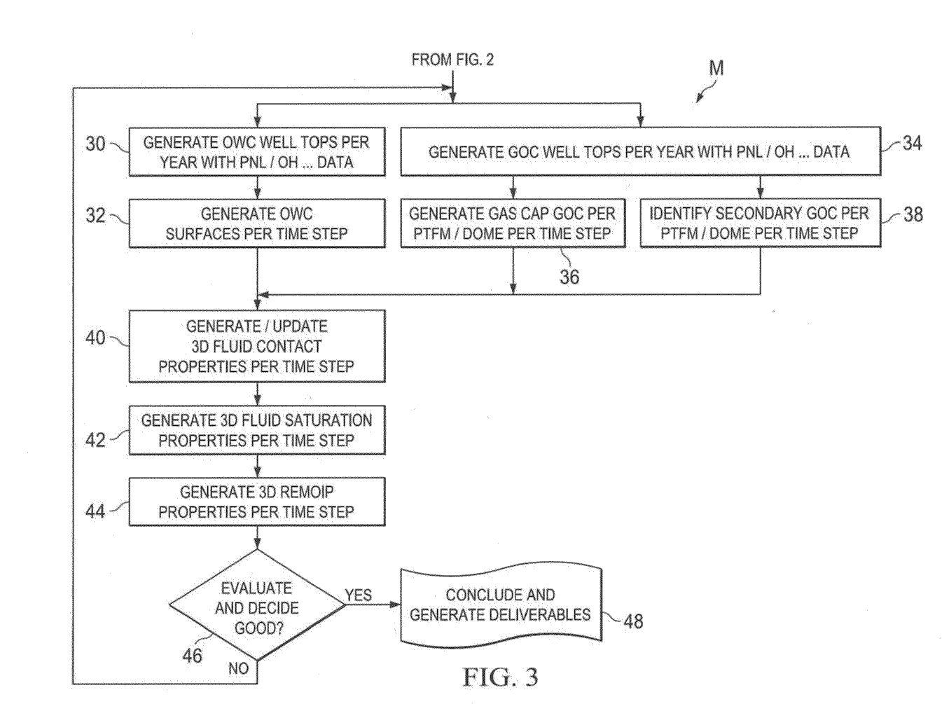

As shown in FIG. 1, processing in data processing system D begins during step 10 (FIG. 1) to form, production based measures of 4D reservoir fluid saturation based on measurements made in or about the reservoir during its production life according to the present invention. The computer implemented determination of production based reservoir fluid saturation measures during step 10 is set forth in more detail in a flow chart I (FIG. 2) and a flow chart M (FIG. 3), as will be set forth below.

During a step 12 of the flowchart F (FIG. 1), a simulation model of fluid saturation of the subsurface is also formed. An example of such a simulation model and its formation is, for example, that of U.S. Pat. No. 7,526,418, which is owned by the assignee of the present invention. The disclosure of such U.S. patent is incorporated herein by reference. It should also be understood that techniques of forming simulation models can also be used, if desired.

The production based fluid saturation measures of the reservoir determined during step 10 and the simulation model of the reservoir during step 12 are formed for various corresponding times during the production life of die reservoir, and are then stored in data memory of the data processing system D. As indicated at step 14 (FIG. 1) composite displays of measures of fluid saturation of a subsurface reservoir from the simulation model determined during step 12 and from the production based model determined during step 10 based on data measurements of wells in the reservoir during production, are formed for comparative analysis.

FIGS. 2 and 3 indicate the basic computer processing sequence of step 10 according to the present invention for forming production based 4D saturation models based on measurements made in or about the reservoir during its production life according to the present invention. The processing sequence of step 10 includes the flow chart I (FIG. 2) illustrating the processing sequence of the present invention relating to formation, of a database and initial, reservoir saturation model based on data obtained from wells in the reservoir and other data sources. The processing sequence of step 10 also includes the flow chart M (FIG. 3) illustrating the sequence for processing data resulting from the procedure's of the flow chart I and data obtained during production from the reservoir for purposes of fluid encroachment modeling, as will, be described in detail below.

Turning to FIG. 2, processing in data, processing system D includes a screening of the available data being conducted aid an inventory of the information being reported. Based on that, missing and wrong format information are identified and corrected and consequently incorporated into the project data base. A petrophysical modeling project is created and the data previously screened is populated at this phase. Geological model, OH logs, PNL logs, production, completion, etc. are populated, and quality control performed. Initial project workflow is revised and modified accordingly. Extensive petrophysics review for entire field is conducted and initial contact is defined. Processing begins during step 20 (FIG. 2) by auditing or collection, collation or arrangement and quality control of input parameters or data for processing according to the present invention. The input parameters or data include the following: an initial set of 3D geological model data for the reservoir of interest; Individual cell dimensions and locations in the x, y and z directions for the reservoir; existing well locations and directions through the reservoir; petrophysical measurements and known values of attributes from core sample data; and data, available from well, logs where log data have been obtained. During step 20, the input parameters and data are thus evaluated and formatted for processing during subsequent steps. If errors or irregularities are detected in certain data during quality control in processing during step 20, such data may be omitted from processing or may be subject to analysis for corrective action to be taken.

During step 22 of processing in the data processing system D, the stored initial 3D geological model data is migrated from database memory for processing by petrophysical modeling. In one embodiment of the present invention, such petrophysical modeling may be performed for Instance by a processing system known as PETREL available from Schlumberger Corporation. It should also be understood that the petrophysical modeling may, if desired, be performed according to other available techniques such as those available as: GOCAD from OoCAD Consortium; Vulcan from Vulcan Software; DataMine from Datamine Ltd; FracSys from Colder Associates, Inc.; GeoBioek from Source Forge; or deepExploration from Right Hemisphere, Inc.; or other suitable source.

During step 24, input saturation data obtained from processing data from well logs including open hole (OH) logs from the wells in the reservoir before production, as well as data eased hole (CH) logs such as pulsed neutron (PNL) or production logging tool (PLT) logs after casing has been installed in wells are populated or made available to be located into the geological model being processed. In addition during step 24, data regarding well production, completion, well markers, well head data, well directional survey are populated or made available to be located into the geological model being processed.

During step 26, a quality control analysis or correlation is made between the geological model data migrated for processing during step 22 and the open hole log data from step 24. If errors or irregularities are detected between geological model data, and open hole log data during quality control in processing during step 26, such data may be omitted from processing or may be subject, to analysis for corrective action to be taken. Also during step 26, a quality control, analysis or correlation is made between the fluid saturation measures available form production log data, open hole log data and also the initial saturation model.

During step 28, initial fluid contacts (for both Free Water Level and Gas-Oil) are determined for each of the various regions, platforms, domes and fields of interest in the reservoir. The processing during step 28 is done by a petrophysical model system of the type described above in connection with step 22. As a result of step 28, a fluid encroachment database and an initial fluid encroachment for the reservoir is formed and available in the data, processing system D for further fluid encroachment modeling according to the step 30 in the flow chart, as will be described.

Fluid encroachment modeling and reservoir analysis (FIG. 3) involves the contacts (GOC, lowest gas, OCW, shale water contact, etc) for entire field being re-evaluated and picked direct in the petrophysical model, creating a data base of contacts for the entire history. The geological model is revised in detail as well the field production and by this, a model is ready. The present invention begins with step 30. During step 30 oil-water contact (OWC) well tops, or the depth of the geological layer wherein such contact occurs, are determined from either or both of PML logs and OH logs. Further, any OWC information reported on well events in the input data is taken into account in the input data. Also, during step 30, indications of oil-water contact (OWC) are generated for each year during previous and projected production life of the reservoir for the well tops in the geological model so that all locations of such contact in the reservoir model are identified. During step 30, OWC in the years where OWC from, logs is hot available are determined by interpolation using measures of production of the well or platform in question, for those years.

Next, during step 32 a measure of the location of OWC surface for each year or time steps over the time of interest for the reservoir is established. During step 32, quality control of OWC surfaces previously generated is performed: Synthetic OWC logs×Water Production.

During step 34 gas-oil contact (GOC) well tops, or the depth of the geological layer wherein such contact occurs, are determined from either or both of PNL logs and OH logs. Further, any GOC information reported on well events in the input data is taken into account in the input data.

During step 36, indications of gas-oil contact (GOC) are generated for each year during previous and projected production life of the reservoir for the well tops in the geological model so that all locations of such contact in the reservoir model are identified. During step 36, GOC in the years where GOC from logs is not available are also determined by interpolation using measures of production of the well or platform in question for those years.

During step 38, indications of secondary GOC are identified and the 3D fluid contact properties determined during step 34 are updated with identified secondary GOC 3D fluid contact for the platforms, regions and domes of interest in the reservoir. Adjustments are also made during step 38 for changes in GOC levels in wells affected by gas conning and the 3D fluid contact model updated accordingly.

During step 40, a 3D fluid contact property is generated for each year or time step over the time of interest for the reservoir. Daring step 40, a quality control analysis or correlation is made between the 3D fluid contact properties for the various time steps generated based on the data from the various logs available from wells in the reservoir: production/completion, OH and PNL. If errors or irregularities are detected in the 3D fluid contact properties, such data may be subject to analysis for corrective action to be taken.

During step 42, a measure of 3D saturation properties is determined for the various time steps of interest, and thus a 4D saturation property for the reservoir of interest is obtained. The 4D saturation property obtained is obtained from actual data measurements obtained for wells in the reservoir before and during production and is thus not based on simulation. Reservoir saturation over the production life is thus determined from production data. Actual fluid movement over time is determined and observed.

From the 4D simulation property obtained during step 42, a 3D measure of remaining oil in place (REMOIP) properties per time step (and thus a 4D REMOIP property) is formed during step 44. Also during step 44, maps of remaining oil in place or REMOIP may be formed for layer or zones of interest in the reservoir being modelled according to the present invention data.

During step 46, the reservoir fluid encroachment measures resulting from saturation modelling according to the present invention are evaluated for accuracy and acceptability. During step 48, if the results of step 46 indicate acceptable results, the results are updated in memory of the data processing system D. The updated results can then be displayed or otherwise made available during step 48 as deliverable output data. If further processing is indicated necessary during step 46, processing returns to steps 30 and 34, as indicated in FIG. 2.

As illustrated in FIG. 4, a data processing system D according to the present invention, includes a computer C having a processor 50 and memory 52 coupled to processor 50 to store operating instructions, control information and database records therein. The computer C may, if desired, be a portable digital processor, such as a personal computer in the form of a laptop computer, notebook computer or other suitable programmed or programmable digital data processing apparatus, such as a desktop computer. It should also be understood that the computer C may be a multicore processor with nodes such as those from Intel Corporation or Advanced Micro Devices (AMD), an HPC Linux cluster computer or a mainframe computer of any conventional type of suitable processing capacity such as those available from International Business Machines (IBM) of Armonk, N.Y. or other source.

The computer C has a user interface 56 and an output data display 58 for displaying output data, or records of lithological facies and reservoir attributes according to the present invention. The output display 58 includes components such as a printer and an output display screen capable of providing printed output information or visible displays in the form of graphs, data sheets, graphical images, data plots and the like as output records or images.

The user interface 56 of computer G also includes a suitable user input device or input/output control unit 60 to provide a user access to control or access information and database records and operate the computer C. Data processing system. D further includes a database 62 stored in computer memory, which may be internal memory 52, of an external, networked, or non-networked memory as indicated at 66 in an associated database server 68.

The data processing system D includes program code 70 stored in memory 52 of the computer C. The program code 70, according to the present invention is in the form of computer operable instructions causing the data processor 50 to perform the computer implemented method of the present invention in the manner described above and illustrated in FIGS. 1 through 3.

It should be noted that program code 70 may be in the form of microcode, programs, routines, or symbolic computer operable languages that provide a specific set of ordered operations that control the functioning of the data processing system D and direct its operation. The instructions of program code 70 may be may be stored. In memory 52 of the computer C, or on computer diskette, magnetic tape, conventional hard disk drive, electronic read-only memory, optical storage device, or other appropriate data storage device having a non-volatile computer usable medium stored thereon. Program code 70 may also be contained on a data storage device such as server 58 as a computer readable medium, as shown.

The method of the present invention performed in the computer C can be implemented utilizing the computer program steps of FIGS. 1, 2 and 3 stored in memory 52 and executable by system processor 50 of computer C. The input data to processing system D are the well log data and other data regarding the reservoir described above.

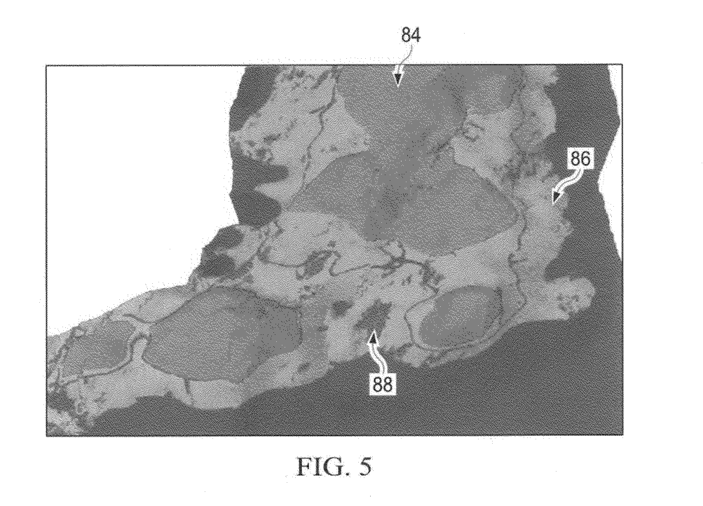

FIG. 5 is a view looking downwardly on an example formation of interest in a 4D saturation model formed of a subsurface reservoir at a particular time during it production life according to the present invention. In FIG. 5, those portions 84 of the formation in red are indicative of saturation values based on processing results where gas is present in the formation, those portions 86 in green are indicative of saturation values where oil is present, and those areas 88 in blue indicate saturation values where water is present. A higher resolution areal sweep can be visualised in different parts of the reservoir to indicate gas oil and water movement. These impressive fluid saturation results were obtained from all historic logging information that can be matched with, dynamic simulation results.

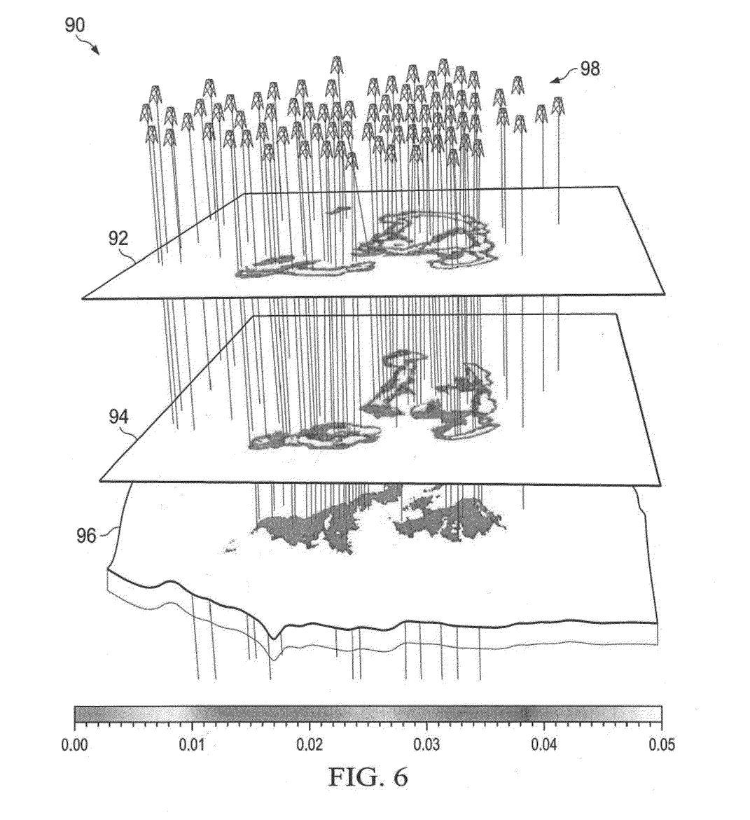

FIG. 6 is a composite display 90 according to the present invention, of fluid saturation of a subsurface reservoir from a simulation model 92 and from a production based model 94 for a geological model 96 at a depth of interest in a reservoir. A simulation model 92 of fluid saturation at the depth of interest is shown a production based or 4D fluid saturation model 94 for a common time of interest. FIG. 6 shows the saturation display from the simulation model 92 at the top and the static model 96 at the bottom while the display 94 in the middle shows the difference between the static model 96 saturations and the saturation from the simulation model 92. Existing wells in the reservoir are indicated at 98 in the composite display 90. Thus, the present invention provides composite model including a production based model 94 from actual reservoir production data at a known time. The saturation model 94 of the present invention based on actual data then can serve as a reference for verifying the simulation model 92 for that known time, and thus serves as an independent check of the simulation model 92.

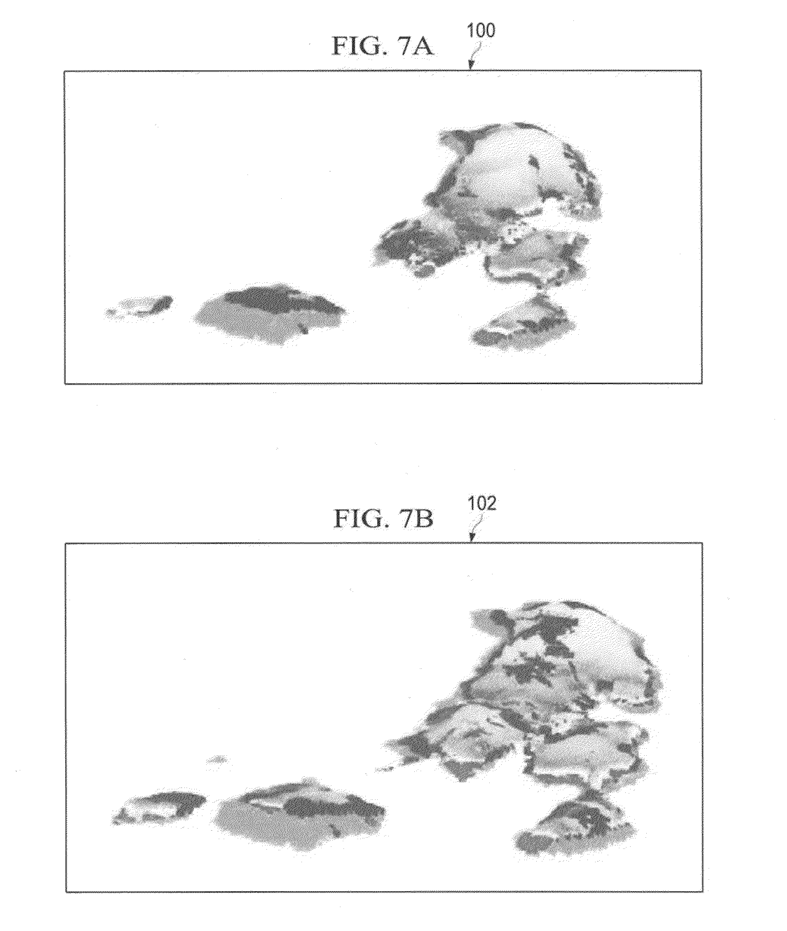

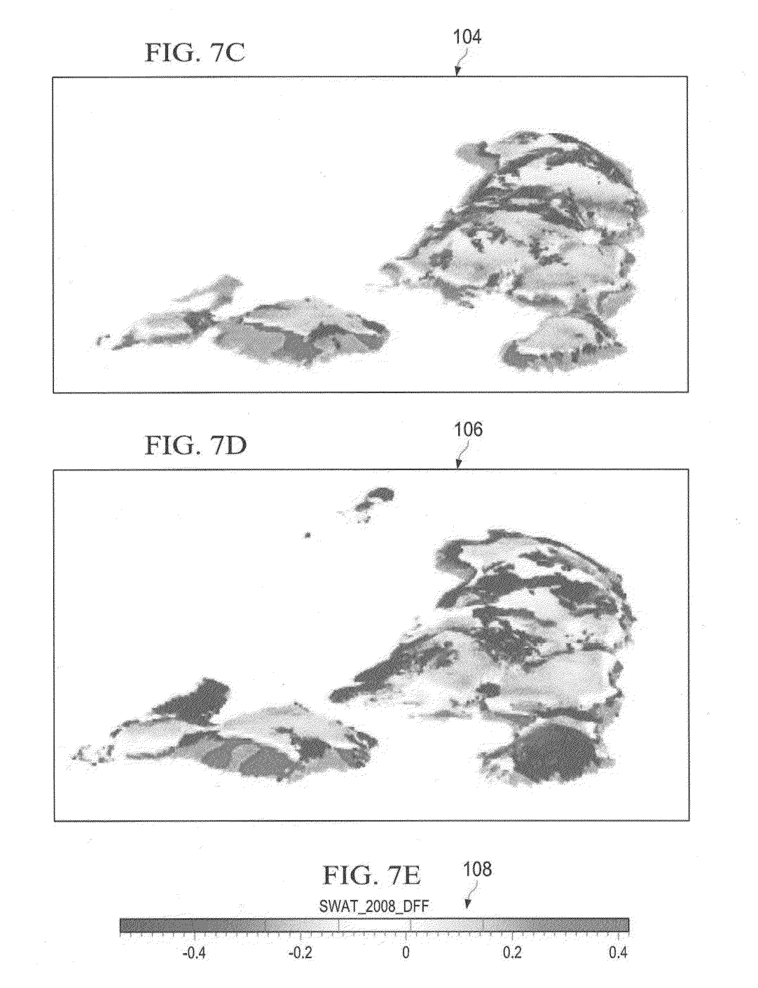

FIGS. 7A, 7B, 7C and 7D are displays 100, 102, 104, and 106, respectively, according to the present invention of differences between fluid saturation changes from a simulation model determined during step 20 and from a production based model determined during step 10 at depths of interest in a reservoir. The differences are arithmetical measures of the two saturation measures, on a cell by cell basis at the region or depth of interest which may be determined during step 14 or as an intermediate step before step 14. The fluid saturation difference measures shown in FIGS. 7A through 7D are differences in water saturation or S_{w} measures at different layers or depths in the model.

A color key or scale 108 (FIG. 1E) indicates by differences in color and intensity the magnitude and nature of the differences between water saturation measures from, a simulation model, and from a production based model in displays such as those FIGS. 7A through 7D. The color blue in these displays indicates that the simulation measures of water saturation are greater in magnitude than the 4D or production based measures. The higher intensity or hue of the color blue indicates a greater difference in the simulation wafer saturation measures, while a lighter blue indicates a lesser difference between the simulation measure and the production based measure. Correspondingly, the color red in the displays indicates that the 4D or production based measures of water saturation are greater in magnitude than the simulation measures. The higher intensity or hue of the color red indicates a greater difference in the production based water saturation measures, while a lighter red indicates a lesser difference between the production based measure and the simulation measure.

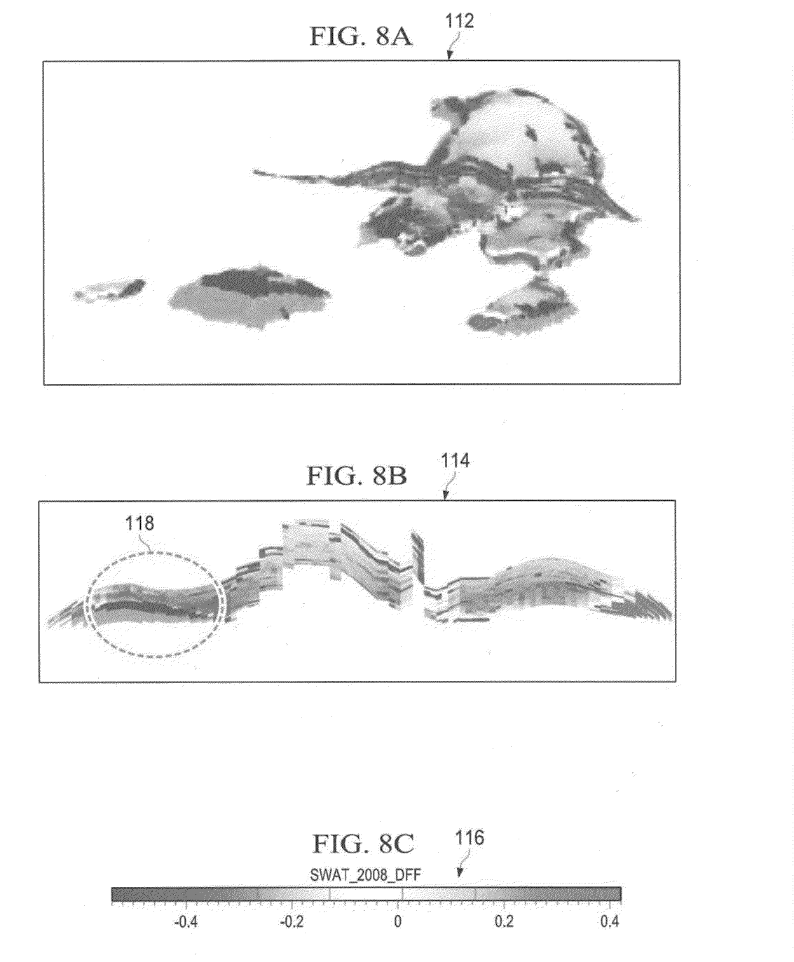

FIG. 8A is a display 112 like those of FIGS. 7A through 7D according to the present invention of differences between water saturation measures from a simulation model and from a production based model at a depth of interest in a reservoir. FIG. 5B is a vertical cross-sectional display 114 of the same subsurface reservoir as the display of FIG. 8A, indicating differences between fluid saturation measures from a simulation model and from a production based model laterally across reservoir as functions of depth at a particular time in its production life. Again, the displays indicate by color and intensity variations in red and blue the difference between production based measures and simulation measures of S_{w} in the manner described above. A color scale or key 116 defines the magnitude of the differences displayed. A region 118 is to be noted in the display 114 of FIG. 8B where the simulation measure shows a markedly lower S_{w} than the production based model.

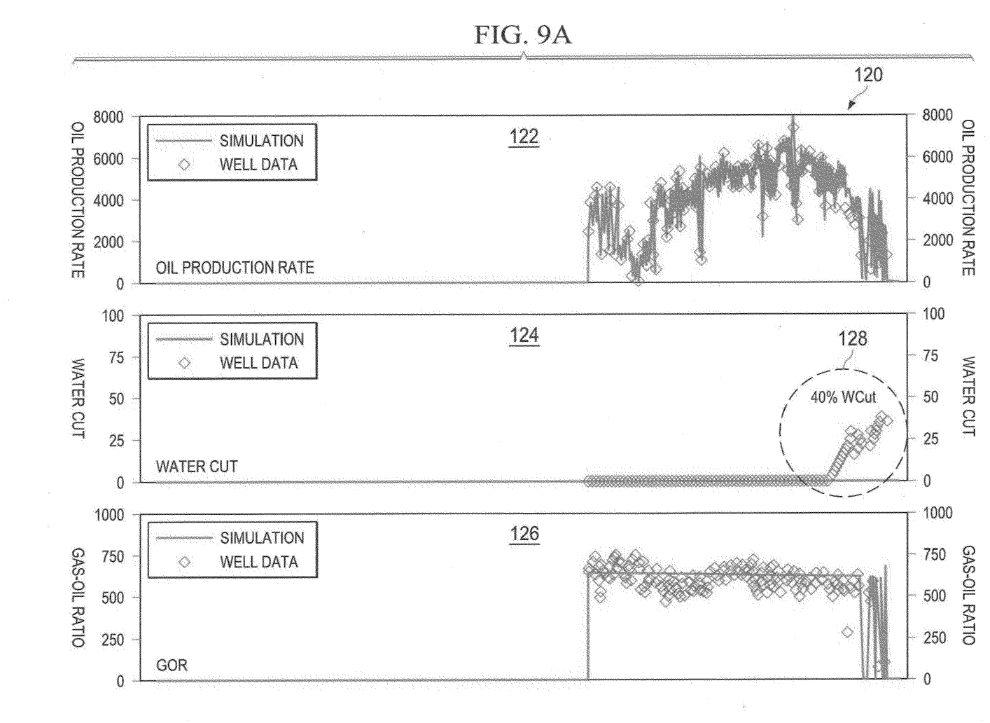

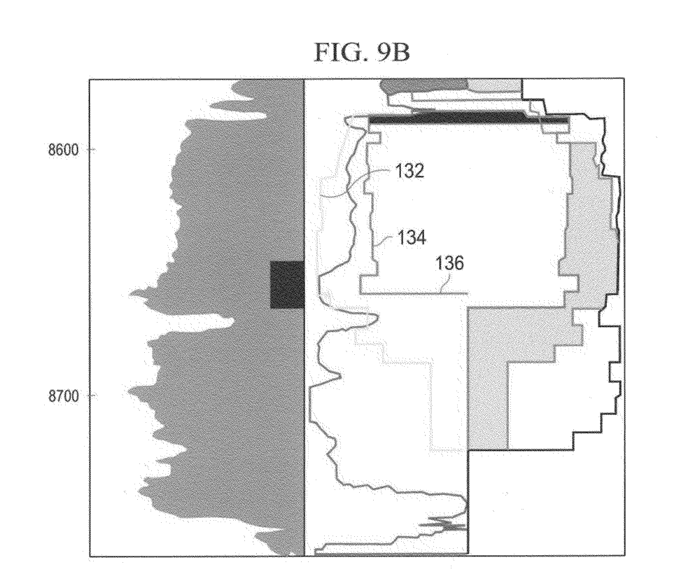

FIG. 9A is a display or plot 120 of comparative measures of reservoir fluid parameters (oil production rate, water cut and gas-oil ratio (GOR)) as functions of time based on simulation models according to the present invention and the actual Held data for a region of interest in a subsurface reservoir. The simulation model measures are plotted as red in plots for each of oil production rate 122, water cut 124 and gas-oil ratio (GOR) 126 for the region of interest. Production data based measures are plotted in black for each of oil production rate 122, water cut 124 and gas-oil ratio (GOR) 126 for the same region of interest over corresponding times. As indicated at 128 in the water cut plot 124, the production based data indicates an increasing water cut from the region of interest over time, while the simulation data indicates little or no change. The saturation modeling techniques according to the present invention as illustrated in FIG. 9A provide an excellent mechanism for detecting or flagging discrepancies between the saturation models and providing quality control, of simulation models.

FIG. 9B is a display or plot 130 of well log measures regarding reservoir water saturation as functions of depth based on the actual field measurements and the simulation model data for a well of interest in the reservoir. A plot 132 represents S_{w} as a function of depth, based on simulation measures, while a plot 134 represents S_{w} as a function, of depth obtained from, production based or 4D measures. It is to be noted that the plot 132 indicates again little or no water cut, while the production based data indicates a water cut of 40% at the same depths. Also the 4D model data indicates at 136 for bottom perforations in the well a value of 100% for residual oil saturation (Sₒᵣ).

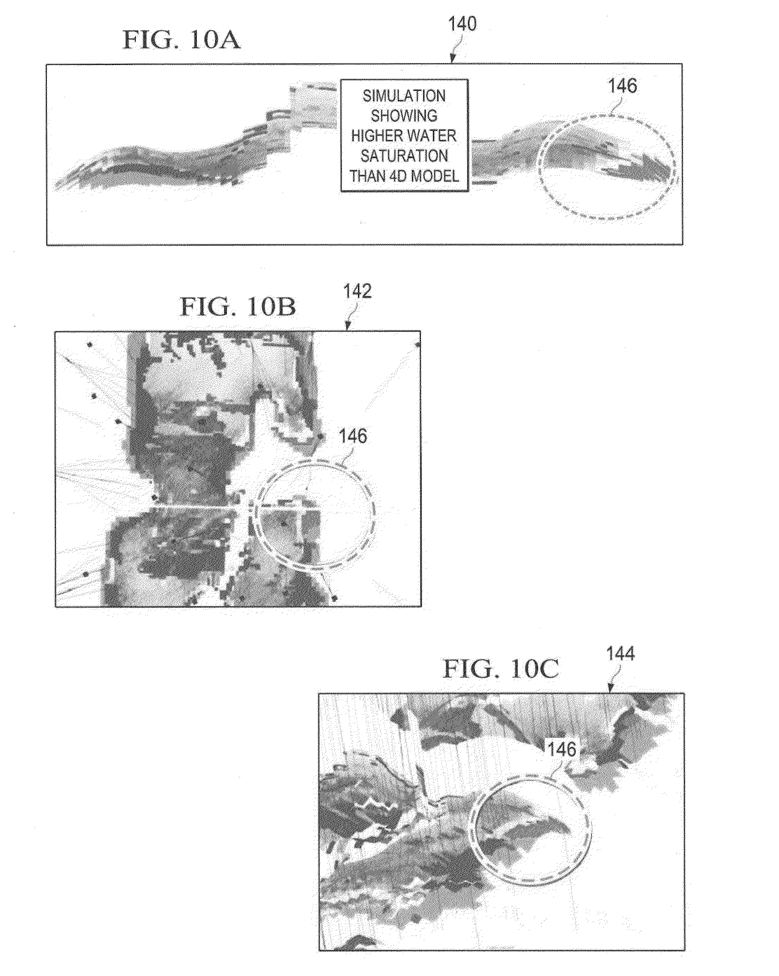

FIG. 10A is a display 140 like that of FIG. 8A according to the present invention of differences between water saturation measures from a simulation model and from a production based model at a depth of interest in a reservoir. FIG. 10B is a vertical cross-sectional display 142 of the same subsurface reservoir as the display of FIG. 10A, while FIG. 10C is an isometric view or display 144 of the same subsurface reservoir. Again, the displays 140, 142 and 144 indicate differences between fluid saturation measures from a simulation model and from a production based model for the reservoir at a particular time in its production life. Again, the displays indicate by color and intensity variations in red and blue the difference between production based measures and simulation measures of Sw in the manner described above. A region 146 is to be noted in each of the displays of FIGS. 10A, 10B and 10C where the simulation measure shows a markedly higher Sw than the production based, model. FIGS. 10A, 10B and 10C are displays to demonstrate the capability of the present invention to highlight areas that need more work in the simulation model.

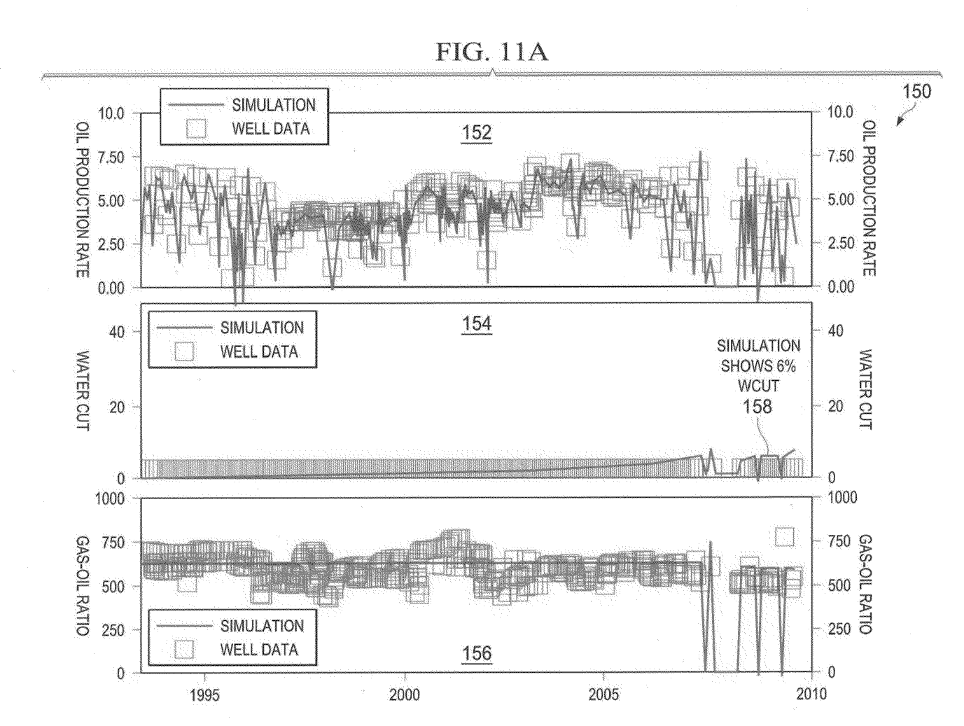

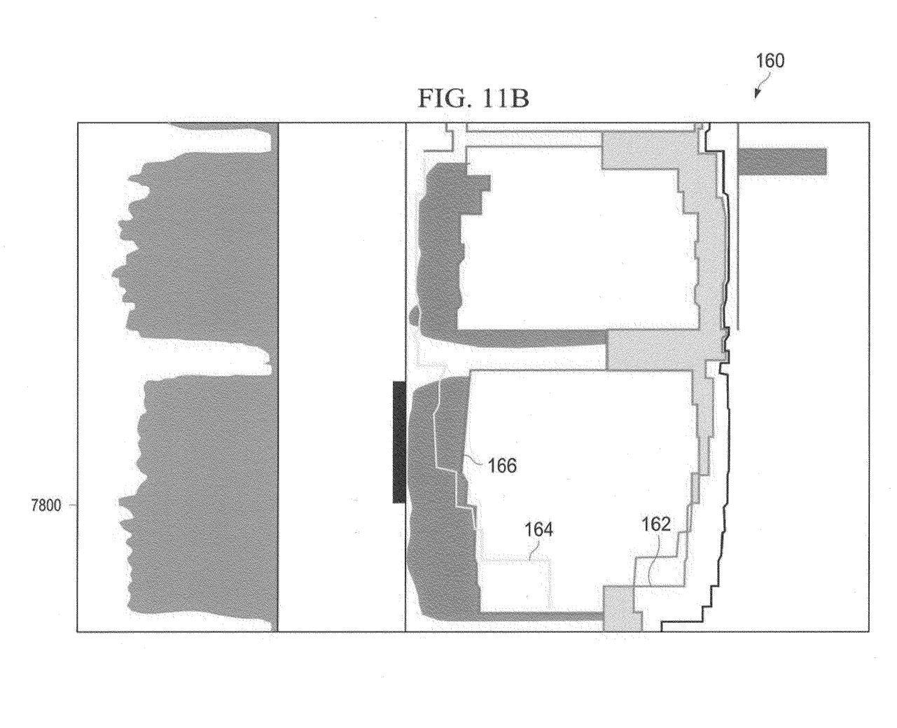

FIGS. 11A and 11B show different individual well performance and log plots that compare actual data with the simulation results. FIG. 11A is a display or plot 150 of comparative measures of reservoir fluid parameters as functions of time based on saturation models according to the present invention for a region of interest in a subsurface reservoir. The simulation model measures are plotted as blue in plots for each of oil production rate 152, water cut 154 and gas-oil ratio (GOR) 156 for the region of interest. Production data based measures are plotted in red for each of oil production rate 152, water cut 154 and gas-oil ratio (GOR) 156 for the same region of interest over corresponding times. As indicated at 158 in the water cut plot 154, the simulation based data indicates a water cut of about 6% from the region of interest over time, while the simulation data indicates a lower value.

FIG. 11B is a display or plot 160 of well log measures regarding reservoir fluid parameters as functions of depth based on the saturation model data from which the data plots of FIG. 11A are based, and for a well of interest in the reservoir. A plot 162 represents S_{w} as a function of depth based on simulation measures, while a plot 164 represents S_{w} as a function of depth obtained from production based or 4D measures. It is to be noted as indicated at 162 that the plot 164 indicates again the same higher water cut shown in FIG. 11A, while the production based data plot 166 indicates a lower water cut at the same depths.

From the foregoing. It can be seen that the present invention, provides saturation models based on actual reservoir data, such as production data and well logs over time during production from the reservoir. Thus, evaluation of fluid presence and movement over time hi the reservoir is available based on actual measured data.

One of the difficult tasks in reservoir engineering is to obtain a perfect match for reservoir simulation models at different time during simulation of reservoir production. However, the present invention provides a reservoir saturation model based on actual data at a known time. The saturation model of the present invention based, on actual data then can serve as a reference for verifying a simulation model for that known time, and thus serves as an independent check of the simulation model.

The invention has been sufficiently described so that a person with average knowledge in the matter may reproduce and obtain the results mentioned in the invention herein Nonetheless, any skilled person in the field of technique, subject of the invention herein, may carry out modifications not described in the request herein, to apply these modifications to a determined structure, or in the manufacturing process of the same, requires the claimed matter in the following claims; such structures shall be covered within the scope of the invention.

It should be noted and understood that there can be improvements and modifications made of the present invention described in detail above without departing from the spirit or scope of the invention as set forth in the accompanying claims.

What is claimed is:

1. A computer implemented method of obtaining measures in a data processing system of fluid saturation of a subsurface reservoir from a simulation model and from, a production based model from data measurements of wells in the reservoir during production, the method comprising the computer processing steps of:
(a) processing initial data about formations in the reservoir received from wells in the reservoir to determine an initial measure of fluid saturation of formations in the reservoir at an initial time;
(b) transferring the determined initial measure of fluid saturation in formations of interest in the reservoir to a data memory of the data, processing system;
(c) processing production data during production subsequent to the initial time from wells in the reservoir to determine production based measures of fluid saturation of formations dining production;
(d) assembling in the data memory the determined production based measures of fluid saturation of formations in the reservoir;
(e) determining a simulation model of fluid saturation of formations in the reservoir; and
(f) forming a composite display of the simulation model of fluid saturation and the determined production based measures of fluid saturation in formations of interest in the reservoir for comparative analysis.

2. The computer implemented method of claim 1, wherein the initial data comprises: initial evaluation log data and well core sample data.

3. The computer implemented method of claim 1, wherein the production data comprises: production log data.

4. The computer implemented method of claim 1, wherein the step of forming a composite display comprises the step of merging a display of the simulation model of fluid, saturation and a display of the determined production based measures of fluid saturation in formations of interest in the reservoir into a single display.

5. The computer implemented method of claim 1, further Including the step of determining differences between die simulation model of fluid saturation and the determined production based measures of fluid saturation.

6. The computer implemented method of claim 5, wherein the step of forming an composite output display comprises the step of forming displays of the determined differences between the simulation model of fluid saturation and the determined production based measures of fluid saturation.

7. The computer implemented method of claim 5, wherein the step of determining differences comprises determining differences between the simulation model of fluid saturation and the determined production based measures of fluid saturation in a formation of interest.

8. The computer implemented method of claim 1, wherein the step of forming a composite display comprises the step of forming adjacent displays of the simulation model of fluid saturation and of the determined production based measures of fluid saturation in formations of interest in the reservoir in the composite display.

9. The computer implemented method of claim 1, wherein the step of forming an output display further includes the step of forming displays of differences between the simulation model of fluid saturation and the determined production based measures of fluid saturation.

10. A data processing system for obtaining measures of fluid saturation of a subsurface reservoir from a simulation model and from a production based model from data measurements of wells in the reservoir during production, the data processing system comprising:
(a) a processor performing the steps of:
(1) processing initial data about formations in the reservoir received from wells in the reservoir to determine an initial measure of fluid saturation of formations in the reservoir at an initial time;
(2) transferring the determined initial measure of fluid saturation in formations of interest in the reservoir to a data memory of the data processing system;
(3) processing production data during production subsequent to the initial time from wells in the reservoir to determine production based measures of fluid saturation of formations during production;
(4) assembling in the memory the determined production based measures of fluid saturation of formations in the reservoir; and
(5) determining a simulation model of fluid saturation of formations in the reservoir;
(b) an output display forming a composite display of the simulation model of fluid saturation and the determined production based measures of fluid saturation in formations of interest in the reservoir for comparative analysis.

11. The data processing system of claim 10, wherein the initial data comprises initial evaluation log data and well core sample data.

12. The data processing system, of claim 10, wherein the production data comprises production log data.

13. The data processing system of claim 10, wherein the display in performing the step of forming images forms a merged display of the simulation, model of fluid saturation and of the determined production based measures of fluid saturation in formations of interest in the reservoir.

14. The data processing system of claim 10, wherein the processor further performs the step of determining differences between the simulation model of fluid saturation and the determined production based measures of fluid saturation.

15. The data processing system of claim 14, wherein the output display further forms displays of the determined differences between the simulation model of fluid saturation and the determined production based measures of fluid saturation.

16. The data processing system of claim 14, wherein the processor determines differences between the simulation model of fluid saturation and the determined production based measures of fluid saturation in a formation of interest.

17. The data processing system of claim 10, wherein the output display forms adjacent displays of the simulation model of fluid saturation and of the determined production based measures of fluid saturation in formations of interest in the reservoir as a composite display.

18. Hie data processing system of claim 10, wherein the output display forms displays of differences between the simulation model of fluid saturation and the determined production based measures of fluid saturation.

19. A data storage device having stored in a computer readable medium computer operable instructions for causing a data processing system to obtain measures of fluid saturation of a subsurface reservoir from a simulation model and from a production based model from data measurements of wells in the reservoir during production, the instructions stored in the data storage device causing the data processing system to perform the following steps:
(a) processing initial data about formations in the reservoir received from wells in the reservoir to determine an initial measure of fluid saturation of formations in the reservoir at an initial time;
(b) transferring the determined initial measure of fluid saturation in formations of interest in the reservoir to a data memory of the data processing system;
(c) processing production data during production subsequent to the initial time from wells in the reservoir to determine production based measures of fluid saturation of formations during production;
(d) assembling in the memory the determined production based measures of fluid saturation of formations in the reservoir;
(e) determining a simulation model of fluid saturation of formations in the reservoir; and
(f) forming a composite display of the simulation model of fluid saturation and the determined production based measures of fluid saturation in formations of interest in the reservoir for comparative analysis.

20. The data storage device, of claim 19, wherein the instructions for forming an composite display include instructions causing the step of merging a display of the simulation model, of fluid saturation and a display of the determined production based measures of fluid saturation in formations of interest in the reservoir into a composite display.

21. The data storage device of claim 19, wherein the instructions for processing production data further cause the step of determining differences between the simulation model of fluid saturation and the determined production based measures of fluid saturation.

22. The data storage device of claim 21, wherein the instructions for forming an output display include instructions causing the step of forming displays of the determined differences between the simulation model of fluid saturation and the determined production based measures of fluid saturation.

23. The data storage device of claim 21, wherein the instructions for processing production data include instructions causing the data processing system to determine differences between the simulation model of fluid saturation and the determined production based measures of fluid saturation in a formation of interest.

24. The data storage device of claim 19, wherein the instructions for forming an output display include instructions causing the step of forming adjacent displays of the simulation model of fluid saturation and the determined production based measures of fluid saturation.
